(19) United States
(12) Patent Application Publication
(10) Pub. No.: US 2025/0333042 A1
(43) Pub. Date: Oct. 30, 2025

(54) VEHICLE AND METHOD OF BRAKING THE VEHICLE

(71) Applicant: Ford Global Technologies, LLC, Dearborn, MI (US)

(72) Inventors: Ruochen Yang, Bloomfield Hills, MI (US); Subha Ponguru, Canton, MI (US); Michael Goebelbecker, Plymouth, MI (US); Madeleine Moir, Ypsilanti, MI (US); Grace Moraca, Carnegie, PA (US)

(73) Assignee: Ford Global Technologies, LLC, Dearborn, MI (US)

(21) Appl. No.: 18/649,322

(22) Filed: Apr. 29, 2024

(51) Int. Cl. B60W 10/18; B60W 10/08

(52) U.S. Cl. CPC B60W 10/18; B60W 10/08; B60W 2520/10; B60W 2540/10

(57) ABSTRACT

A motor vehicle comprising a brake system having a brake pedal actuated by a driver to apply braking force to the motor vehicle, a brake pedal sensor sensing an actuation force to the brake pedal, a vehicle speed sensor sensing speed of the motor vehicle, an accelerator input, one or more doors, one or more door sensors configured to sense an open or closed position of the one or more doors, and a controller configured to determine when the vehicle speed indicates the motor vehicle is in a stopped state and in a drive mode with at least one of the one or more doors sensed in the open position. The vehicle is held stationary from unintentional movements until all conditions are met to enable motion.

### FIELD OF THE DISCLOSURE

The present disclosure generally relates to vehicle braking, and more particularly relates to braking a motor vehicle when the driver's manual braking effort does not maintain sufficient brake pedal force to hold the vehicle stationary after the vehicle has stopped.

### BACKGROUND OF THE DISCLOSURE

Motor vehicles are typically equipped with a brake pedal that is manually actuatable by a driver's foot for applying braking force to brake the motor vehicle. When the motor vehicle is stopped and insufficient braking force is applied to the brake pedal, some motor vehicles when operating in the drive mode may continue to move, such as when an internal combustion engine idles or electric motor that is still in gear. It would be desirable to provide for a motor vehicle that maintains a braking force when stationary conditions are desired.

### SUMMARY OF THE DISCLOSURE

According to a first aspect of the present disclosure, a motor vehicle comprising a brake system having a brake pedal configured to be actuated by a driver of the vehicle to apply braking force to the motor vehicle, a brake pedal sensor sensing an actuation force to the brake pedal, a vehicle speed sensor sensing speed of the motor vehicle, an accelerator input, one or more doors, and one or more door sensors configured to sense an open or closed position of the one or more doors. A controller is configured to determine when the vehicle speed indicates the motor vehicle is in a stopped state and in a drive mode with at least one of the one or more doors sensed in the open position. The controller also controls the brake system to brake the motor vehicle unless the driver actuates the accelerator input.

Embodiments of the first aspect of the present disclosure can include any one or a combination of the following features:
the brake system brakes the motor vehicle to hold the vehicle at zero speed;
the controller controls the brake system to release the brake when an accelerator input is sensed;
a motor to accelerate the vehicle in response to the accelerator input;
the accelerator input comprises an accelerator pedal;
the door comprises a passenger door;
the door comprises a rear door;
the door comprises one of a trunk, a tailgate and a liftgate;
the door comprises one of a front door, a hood and a frunk; and
the drive mode comprises a forward drive mode or a reverse gear mode.

According to a second aspect of the present disclosure, a method of controlling a brake system on a motor vehicle is provided. The method senses a driver of the motor vehicle actuating a brake pedal to brake the motor vehicle, the vehicle speed indicative of the motor vehicle in a stopped state, the motor vehicle is in a drive mode, one or more doors of the motor vehicle in an open position, and insufficient braking force applied to the brake pedal by the driver of the motor vehicle to brake the motor vehicle to maintain the motor vehicle in the stopped state. The method further provides controlling the brake system with a controller to brake the motor vehicle while the motor vehicle is in the stopped state and the one or more doors are sensed in the open position.

Embodiments of the second aspect of the present disclosure can include any one or a combination of the following methods:
the step of detecting an accelerator input being activated by the driver and canceling the braking of the motor vehicle with the controller upon detecting the accelerator input being activated;
the accelerator input comprises an accelerator pedal;
the motor vehicle accelerates based on the accelerator input;
the step of sensing a door in an open position comprises sensing a side door in an open position;
the step of sensing one or more doors in an open position comprises sensing a rear or front door of the motor vehicle in an open position;
the rear door comprises one of a trunk, a tailgate and a liftgate;
the front door comprises one of a frunk and a hood; and
the motor vehicle accelerates based on the accelerator input.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a motor vehicle shown having an open door and an open trunk and configured with a brake control system;

FIG. 2 is a block diagram illustrating the brake control system for the motor vehicle of FIG. 1; and

FIG. 3 is a flow diagram illustrating a routine for controlling the brake system of the motor vehicle, according to one embodiment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

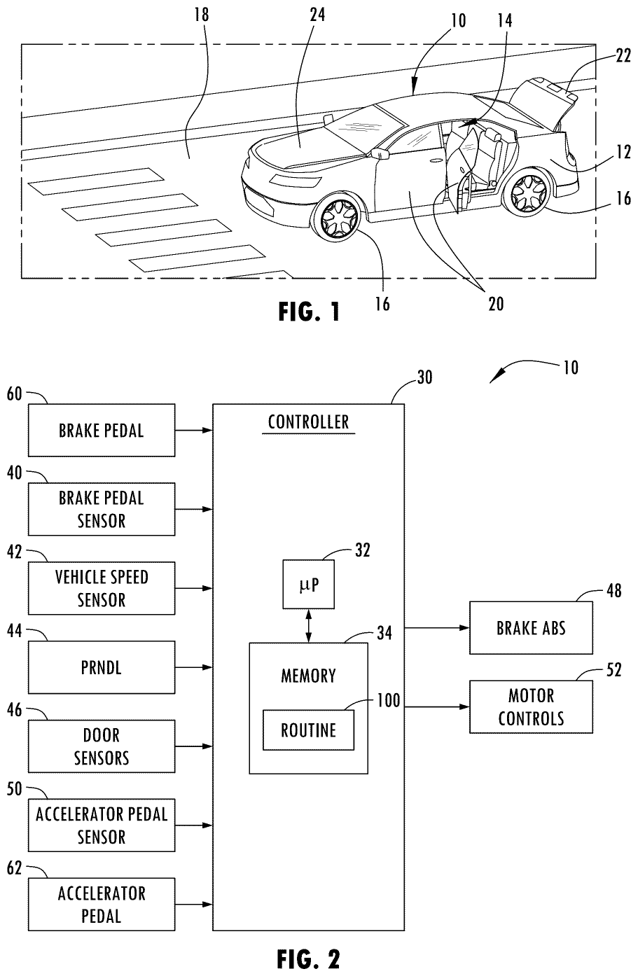

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a motor vehicle and method of controlling the brake system of the motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, an automotive or motor vehicle 10 in the form of a wheeled motor vehicle is generally illustrated, according to one example. The motor vehicle 10 generally includes a body 12 which generally defines a cabin interior, also referred to as a passenger compartment 14. In the example shown, the motor vehicle 10 is a wheeled motor vehicle having a plurality of tire and wheel assemblies 16 configured to contact and roll on the top surface of a roadway 18.

The motor vehicle 10 includes a motor to power the vehicle which may include an internal combustion engine, one or more electric motors in a battery electric vehicle, or a hybrid vehicle, for example. The motor powers the motor vehicle 10 and enables the motor vehicle 10 to accelerate while operating in a forward drive mode or a reverse drive mode. With an internal combustion engine, for example, the motor vehicle 10 may have a transmission with park, reverse, drive, neutral, and low gear (PRDNL) operating modes which include the park (P) mode, the reverse (R) mode, the drive mode (D), the neutral mode (N), and the low gear drive mode (L). When the motor vehicle 10 is in a drive mode such as drive (D) mode, the low gear (L) mode, or the reverse (R) mode, an internal combustion engine may power the motor vehicle 10 including while the engine is idling to move the vehicle, even when the motor vehicle 10 starts at zero speed, without sufficient braking applied.

The motor vehicle 10 includes a plurality of access doors, shown having side doors 20 for allowing passengers to enter and exit the passenger compartment 14. The plurality of doors also includes a rear end door, also referred to as a trunk 22, and a front door, also referred to as a frunk door 24. The rear door may otherwise be configured as a liftgate or swing door, in other examples. The frunk door 24 may be considered a hood which may cover an engine compartment having a motor such as an internal combustion engine may cover or one or more electric motors and provide available space for storage for an electric vehicle, for example.

The motor vehicle 10 is generally configured as a passenger motor vehicle having a seating arrangement configured to provide for seating for a driver of the motor vehicle 10 and one or more passengers. The driver seat seating arrangement includes a generally located vehicle rearward of the vehicle operating driver controls, including a steering wheel, an accelerator pedal, and a brake pedal. The driver of the motor vehicle 10 may actuate the accelerator pedal by applying force to the accelerator pedal via a foot to accelerate the motor vehicle 10 and may actuate the brake pedal by applying force to the brake pedal to brake the motor vehicle 10 pursuant to a braking system, such as an antilock brake system (ABS). The accelerator pedal and brake pedal are typically located in a footwell area forward of the driver's seat and is configured to be actuated by a foot of the driver. Passenger seats may be arranged adjacent to the side of the driver seat and in one or more rearward rows of seating.

The motor vehicle 10 is configured with a brake control system shown in FIG. 2 for controlling vehicle braking to accommodate the driving situation where the motor vehicle 10 is stopped with one or more doors in an open position and when the driver partially or fully releases his or her foot from the brake pedal. When this situation occurs, the motor vehicle 10 is controlled by a controller to apply braking force with the brake system to prevent the motor vehicle 10 from moving until the driver of the motor vehicle 10 applies an acceleration input by actuating the accelerator pedal. This prevents the motor vehicle 10 from moving while in a drive mode either forward or rearward, particularly if the driver inadvertently removes his or her foot from the accelerator pedal.

The motor vehicle 10 includes as part of the brake control system a controller 30 which is shown in FIG. 2 having control circuitry in the form of a microprocessor 32 and memory 34. Stored within memory 34 and executed by the microprocessor 32 is a braking control routine 100. The controller 30 is in communication with a brake pedal sensor 40 to receive a brake pedal signal indicative of the actuation force applied to the brake pedal 60. The brake pedal sensor 40 may sense braking force or pressure applied by a user of the brake pedal 60. In addition, the controller 30 receives a vehicle speed signal from a vehicle speed sensor 42 indicative of the speed of the vehicle, particularly whether the motor vehicle 10 is stopped in a stopped state with a speed of zero to activate the hold mode. Further, the controller 30 receives a vehicle operating mode signal from the PRNDL transmission gear 44 indicative of the gear selection operating mode which indicates whether or not the motor vehicle 10 is operating in a drive mode. It should be appreciated that the motor vehicle 10 may be operating in a forward high drive mode D or forward low drive mode L when the transmission gear 44 is in drive or low gear and may be operating in a rearward drive mode R when the transmission gear 44 is in reverse. The controller 30 further receives door sensor signals from door sensors 46 associated with each of the one or more doors which may include the side doors, the trunk and the frunk. The door sensor signals are indicative of whether one or more of the vehicle doors are in an open position or a closed position. The controller 30 receives an acceleration signal from an accelerator pedal sensor 50 indicative of a driver of the motor vehicle forcibly actuating the accelerator pedal 62 to command the motor vehicle to accelerate the motor vehicle. The accelerator pedal sensor 50 may sense accelerator force or pressure applied by a driver to the accelerator pedal 62.

The controller 30 advantageously processes the various inputs, including the brake pedal sensor 40 signal, the vehicle speed sensor 42 signal, the transmission gear 44 signal, the door sensors 46 signals, and the accelerator pedal sensor 50 signals, according to the control routine 100 and generates an output signal that is applied to the brake control system which is shown as a brake antilock brake system (ABS) 48 and motor controls 52. The output signal applied by the controller 30 to the antilock brake system 48 advantageously may command the brake system to brake the motor vehicle 10 when the motor vehicle 10 is stopped in the hold mode.

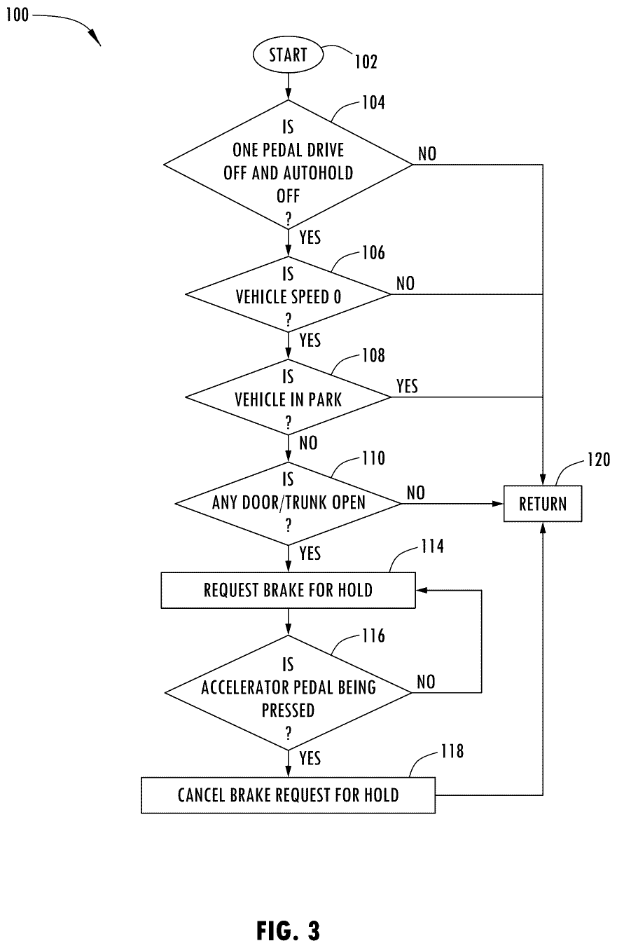

Referring to FIG. 3, the brake control routine 100 is illustrated, according to one example. The control routine 100 begins at step 102 and proceeds to decision step 104 to determine if other operating modes, such as the one pedal drive mode, is off and the auto hold mode is off, for example, and, if not, returns to step 120. Otherwise, if the one pedal drive mode and auto hold modes are not off, routine 100 proceeds to decision step 106 to determine if the motor vehicle speed is zero, indicative of the motor vehicle being stopped. If the motor vehicle speed is not zero, routine 100 returns to step 120. If the motor vehicle speed is zero, indicative of a stopped vehicle, routine 100 proceeds to decision step 108 to determine if the vehicle transmission is operating in the park (P) mode or neutral (N) mode and, if so, returns to step 120. If the vehicle transmission is not in park mode or neutral mode, routine 200 proceeds to decision step 110 to determine if any of the doors of the motor vehicle are in the open position. If there are no open doors, routine 100 returns to step 120. If one or more of the doors of the motor vehicle are in the open position, routine 100 proceeds to decision step 114 to request brake actuation for the vehicle hold mode. Next, routine 100 will proceed to decision step 116 to determine if the accelerator pedal is being pressed or actuated by the driver of the motor vehicle 10 and, if not, returns to step 114. Once the accelerator pedal is pressed by the driver of the motor vehicle 10, routine 100 will cancel the brake request for the hold mode at step 118 and thereby allow the motor vehicle 10 to be powered to accelerate in a drive mode.

It should be appreciated that the motor vehicle 10 advantageously provides for control of the brake system of the motor vehicle 10 to maintain motor vehicle braking in the vehicle hold mode when the motor vehicle 10 is operating in a drive mode such as with a forward or reverse drive gear mode, the motor vehicle is stopped, one or more doors of the motor vehicle 10 are in the open position. The motor vehicle 10 remains in the vehicle drop off mode until the driver of the motor vehicle 10 applies sufficient force to the accelerator pedal, thereby allowing the motor vehicle 10 to proceed to accelerate. This advantageously prevents motor powered travel of the motor vehicle 10 during an inadvertent release of the brake pedal under these circumstances.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A motor vehicle comprising:
a brake system having a brake pedal configured to be actuated by a driver of the motor vehicle to apply braking force to the motor vehicle;
a brake pedal sensor sensing an actuation force to the brake pedal;
a vehicle speed sensor sensing speed of the motor vehicle;
an accelerator input;
one or more doors;
one or more door sensors configured to sense an open or closed position of the one or more doors; and
a controller configured to determine when the vehicle speed indicates the motor vehicle is in a stopped state and in a drive mode with at least one of the one or more doors sensed in the open position, and controlling the brake system to brake the motor vehicle unless the driver actuates the accelerator input.

2. The motor vehicle of claim 1, wherein the brake system brakes the motor vehicle to hold the vehicle at zero speed.

3. The motor vehicle of claim 2, wherein the controller controls the brake system to release the brake when an accelerator input is sensed.

4. The motor vehicle of claim 1, further comprising a motor to accelerate the vehicle in response to the accelerator input.

5. The motor vehicle of claim 1, wherein the accelerator input comprises an accelerator pedal.

6. The motor vehicle of claim 1, wherein the door comprises a passenger door.

7. The motor vehicle of claim 1, wherein the door comprises a rear door.

8. The motor vehicle of claim 7, wherein the door comprises one of a trunk, a tailgate and a liftgate.

9. The motor vehicle of claim 1, wherein the door comprises one of a front door, a hood and a frunk.

10. The motor vehicle of claim 1, wherein the drive mode comprises a forward drive mode or a reverse gear mode.

11. A method of controlling a brake system on a motor vehicle, the method comprising:
sensing a driver of the motor vehicle actuating a brake pedal to brake the motor vehicle;
sensing the vehicle speed indicative of the motor vehicle in a stopped state;
sensing the motor vehicle is in a drive mode;
sensing one or more doors of the motor vehicle in an open position;
sensing insufficient braking force applied to the brake pedal by the driver of the motor to brake the motor vehicle to maintain the motor vehicle in the stopped state; and
controlling the brake system with a controller to brake the motor vehicle while the motor vehicle is in the stopped state and the one or more doors are sensed in the open position.

12. The method of claim 11, further comprising the step of detecting an accelerator input being activated by the driver and canceling the braking of the motor vehicle with the controller upon detecting the accelerator input being activated.

13. The method of claim 12, wherein the accelerator input comprises an accelerator pedal.

14. The method of claim 13, wherein the motor vehicle accelerates based on the accelerator input.

15. The method of claim 11, wherein the step of sensing a door in an open position comprises sensing a side door in an open position.

16. The method of claim 11, wherein the step of sensing one or more doors in an open position comprises sensing a rear or front door of the motor vehicle in an open position.

17. The method of claim 11, wherein the rear door comprises one of a trunk, a tailgate and a liftgate.

18. The method of claim 11, wherein the front door comprises one of a frunk and a hood.

19. The method of claim 13, wherein the motor vehicle accelerates based on the accelerator input.
